(19) United States
(12) Patent Application Publication
(10) Pub. No.: US 2007/0164582 A1
(43) Pub. Date: Jul. 19, 2007

(54) Sun visor for motor vehicle

(75) Inventors: Kunihiko Ishikura, Aichi (JP); Chihiro Tsuzuki, Aichi (JP)

Correspondence Address: CONLEY ROSE, P.C., P. O. BOX 3267, HOUSTON, TX, 77253-3267, US

(73) Assignees: Kyowa Sangyo Co., Aichi (JP); Shinwa Sieko Co., Aichi (JP)

(21) Appl. No.: 10/539,249

(22) PCT Filed: Dec. 15, 2003
(86) PCT No.: PCT/JP03/16051

§ 371 Date: Dec. 6, 2005

(30) Foreign Application Priority Data
Dec. 16, 2002 (JP) 2002-364140

(51) Int. Cl. B60J 3/00

(52) U.S. Cl. 296/97.2

(57) ABSTRACT

A vehicle sun visor 1 includes a sun visor main body 2 attached to the interior of a vehicle via a holding shaft 10. The sun visor main body 2 has an external frame 3 which is frame-shaped and provided along the outer edge of the sun visor main body 2, and a plate member 4 releasably attached in such a position so as to occupy an open window 5 penetrating at the central portion of the external frame 3. The plate member 4 can be attached and detached by sliding the plate member 4 along a sliding groove 8 provided on the external frame 3.

### TECHNICAL FIELD

The present invention relates to a vehicle sun visor provided for shading the interior of a vehicle or other purposes.

### BACKGROUND ART

Currently, a vehicle sun visor provided for shading the interior of a vehicle or other purposes is disclosed in Japanese Patent No. 1,888,746, for example.

According to the vehicle sun visor shown in Japanese Patent No. 1,888,746, an open window penetrates the center portion of a sun visor main body so as to open to both faces thereof, and one of external panels having various different functions is selected and attached to the open window. A front-back pair of the external panel and a supporting panel covering the respective openings of the open window are releasably attached to each other by the elastic engagement between an engaging protrusion and an engaging concave formed on the opposed faces of the external panel and the supporting panel.

The structure shown in the above reference allows various types of sun visors to be provided by the following method. First, one of the external panels such as one equipped with a mirror, a mirror having a lamp, or a ticket holder, is selected. Subsequently, the selected external panel and the supporting panel are fitted from both the openings of the open window, and are then releasably attached to each other by the elastic engagement between the opposed engaging protrusion and engaging concave.

However, the conventional vehicle sun visor described above requires labor in exchanging the external panels. Because the attachment and detachment of the external panel to and from the sun visor main body is made by the elastic engagement between the engaging protrusion and the engaging concave formed on the opposed faces of the supporting panel and the external panel, the process for fitting the supporting panel and the external panel with the sun visor main body inserted there between is required for the attachment and detachment of the external panel. Appropriate positioning of the engaging protrusion and the engaging concave with respect to each other (both of which are located in an area which cannot be seen) is also considerably troublesome.

Therefore, in order to solve the above problems, it is an object of the invention to provide a vehicle sun visor in which a part of a sun visor main body is attachable and detachable so as to freely change the function, design, or the like, of the sun visor. The attachment or the detachment of the appropriate part of the sun visor main body is highly facilitated.

### DISCLOSURE OF THE INVENTION

In order to achieve the above object, a vehicle sun visor according to the invention has a sun visor main body that includes an external frame attached to the interior of a vehicle via a supporting shaft, and a plate member releasably attached in such a position so as to close an open window penetrating the center of the external frame. The vehicle sun visor is characterized in that the external frame has a sliding structure, which allows the plate member to be slidingly attached. According to this vehicle sun visor, the following advantages can be offered: the plate member attached to the external frame can be easily replaced with another plate member having a different pattern, design, color, or the like; the plate member attached to the external frame can be easily replaced with another plate member having an additional function or functions, for example such as operating as a card holder and containing perforations for visibility and/or light; and the appearance (i.e., design) of the sun visor main body as viewed from the front or back thereof can be simultaneously altered since the plate member is attached in such a position so as to fill the open window formed within the center of the external frame. Thus, the function and the appearance of the vehicle sun visor can be easily altered in accordance with the taste, purpose, or the like, of a user.

In the vehicle sun visor according to the invention, the sliding structure for attaching the plate member has an insertion opening provided along a side of the external frame and a sliding groove for holding the outer edge of a plate member inserted through the insertion opening. In this case, the plate member can be easily attached to the external frame simply by inserting one end of the plate member into the insertion opening.

In the vehicle sun visor according to the invention, it is preferable that a cover cap is provided at the insertion opening so as to restrict the movement of the plate member by the cover cap. In this case, it is possible to prevent not only the inadvertent removal of the plate member from the insertion opening, but also prevent the displacement of the plate member from being attached in such a position as to substantially fill the open window.

In order to achieve the above object, a vehicle sun visor according to the invention has a sun visor main body that includes an external frame attached to the interior of a vehicle via a supporting shaft, and a plate member releasably attached in such a position so as to occupy an open window penetrating the center of an external frame. The vehicle sun visor is characterized in that the external frame and the plate member respectively have a concave section and a convex section. This allows the attachment and detachment of the plate member to and from the external frame by engagement between the concave section and the convex section. In this structure, the following advantages can be offered: the plate member attached to the external frame can be easily replaced with another plate member having a different pattern, design, color, or the like; the plate member attached to the external frame can be easily replaced with another plate member having an additional function or functions such as a card holder, see through perforations, etc; and the appearance (i.e., design) of the sun visor main body as viewed from the front or back thereof can be simultaneously changed or altered since the plate member is attached in such a position as to occupy the open window formed at the center of the external frame. Thus, the function and the appearance of the vehicle sun visor can be easily altered in accordance with the taste, purpose, or the like, of a user. Moreover, since the concave section and the convex section used for attaching and detaching the plate member to and from the external frame (i.e., via engagement between the concave section and the convex section) are respectively provided on the external frame and the plate member, the attachment and detachment of the plate member to and from the external frame is readily facilitated.

In the vehicle sun visor according to the invention, the plate member includes a sheet having a design and a transparent plate or plates disposed on one face or both faces of the sheet. The “sheet” herein refers to a thin sheet component having a pattern, design, color, and the like such as paper, cloth, and resin film for example. Since the transparent plate or plates are disposed on one face or both faces of the sheet, the pattern, design, and the like, of the sheet surface can be visually observed through the transparent plate. In addition, the transparent plate or plates provided on the sheet can protect the pattern and design of the sheet from external heat, friction, dust, damage, or the like. This structure is also quite inexpensive since only the sheet made of paper or the like needs to be changed (without requiring the replacement of the transparent plates) when it is desired to alter the appearance of the vehicle sun visor.

In the vehicle sun visor according to the present invention, it is preferable that the plate member includes a semi-transparent plate or a perforated plate. As the semi-transparent plate or the perforated plate transmits light, the transmissibility of light entering from the outside of the vehicle can be controlled via the exchange of a plate member.

### BRIEF DESCRIPTION OF THE DRAWINGS

FIG. 1 is a front view illustrating the external appearance of a vehicle sun visor of a first embodiment;

FIG. 2 is a front view illustrating a condition during the time of attachment of a plate member along a sliding groove formed in an external frame;

FIG. 3 is a side view of the vehicle sun visor shown in FIG. 1 as viewed in the direction indicated by the arrows of the line A-A;

FIG. 4 is a cross-sectional view of the vehicle sun visor shown in FIG. 1 taken along a line B-B as viewed in the direction indicated by the arrows of the line B-B;

FIG. 5 is a perspective view of the plate member in the form of a lamination;

FIG. 6 is a front view illustrating the external appearance of a vehicle sun visor in a second embodiment;

FIG. 7 is a front view of a plate member of the vehicle sun visor shown in FIG. 6;

FIG. 8 is a cross-sectional view of the vehicle sun visor shown in FIG. 6 taken along a line C-C as viewed in the direction indicated by the arrows of the line C-C;

FIG. 9 is a cross-sectional view of the vehicle sun visor shown in FIG. 6 taken along a line D-D as viewed in the direction indicated by the arrows of the line D-D;

FIG. 10 is a cross-sectional view illustrating a condition at the time of attachment of the plate member to an external frame; and

FIG. 11 is a front view illustrating the external appearance of a vehicle sun visor not having a cover cap.

### BEST MODE FOR CARRYING OUT THE INVENTION

### First Embodiment

A first embodiment according to the invention is hereinafter described with reference to the drawings.

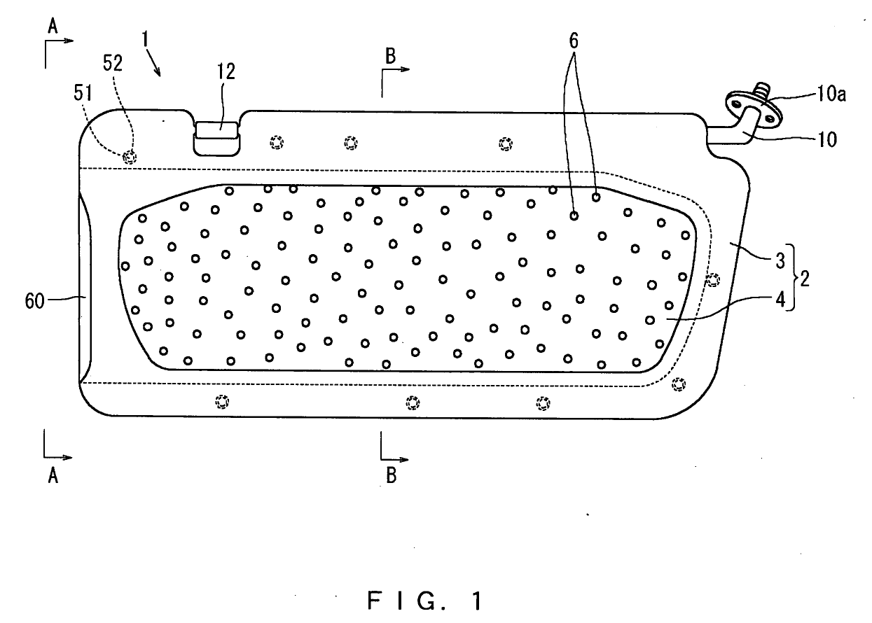

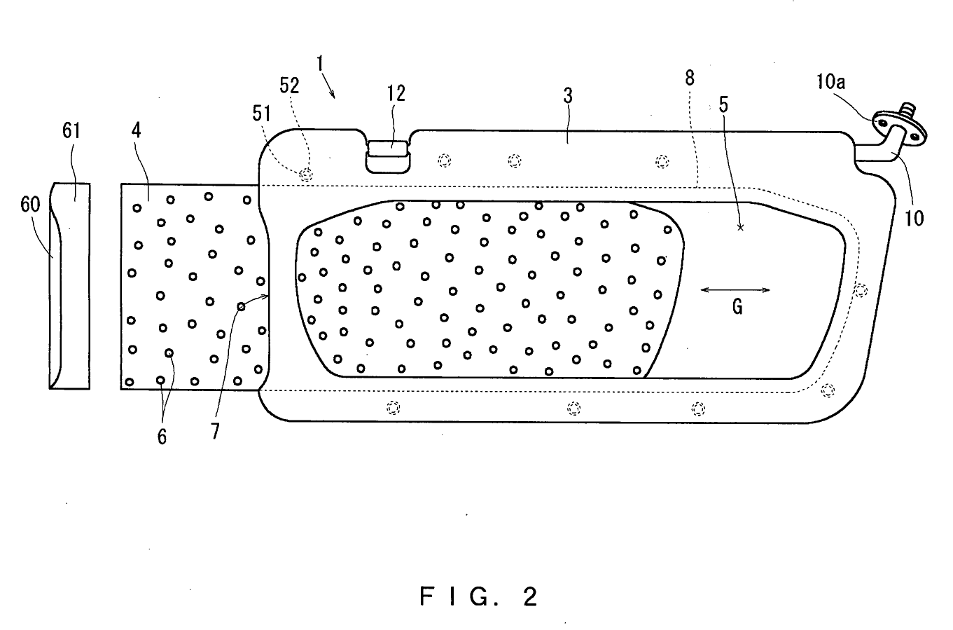

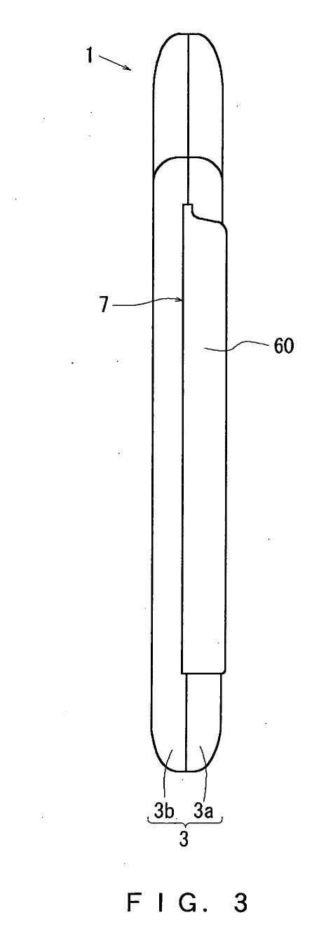

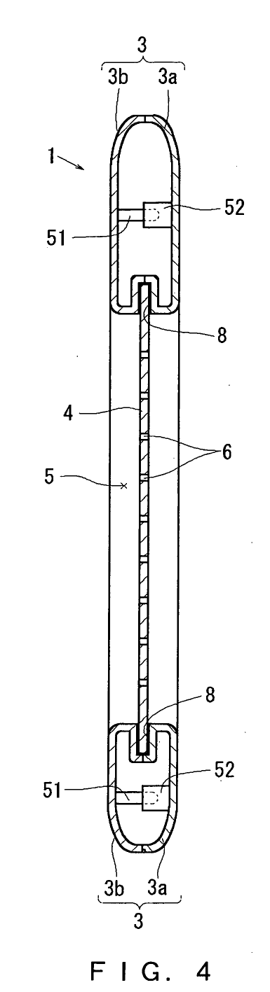

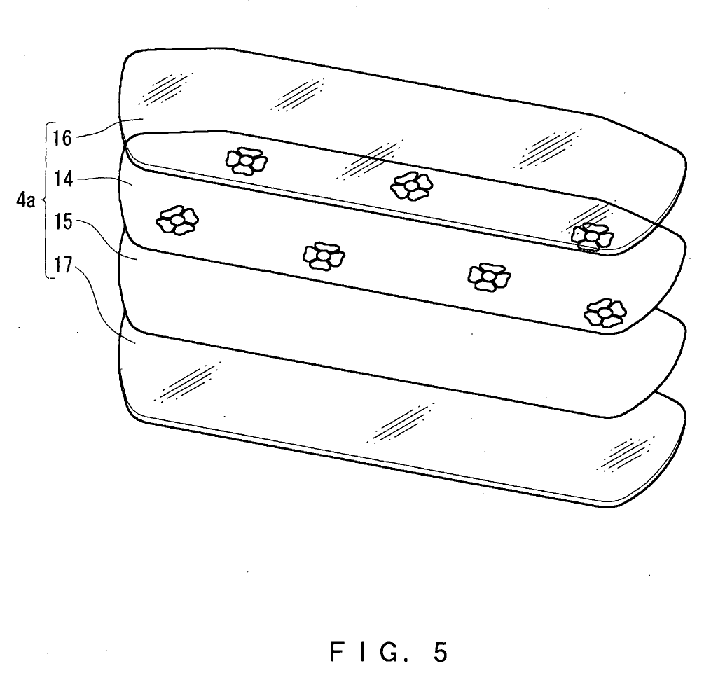

FIG. 1 is a front view illustrating the external appearance of a vehicle sun visor 1 in the first embodiment. FIG. 2 is a front view illustrating a condition at the time of attachment of a plate member 4 along a sliding groove 8 formed in an external frame 3. FIG. 3 is a side view of the vehicle sun visor 1 shown in FIG. 1 as viewed in the direction indicated by the arrows of the line A-A. FIG. 4 is a cross-sectional view of the vehicle sun visor 1 shown in FIG. 1 taken along a line B-B as viewed in the direction indicated by the arrows of the line B-B. FIG. 5 is a perspective view of a plate member 4 formed of a lamination.

As illustrated in FIG. 1, the vehicle sun visor 1 in this embodiment is primarily constituted by a sun visor main body 2, which is used for blocking sunlight or the like from entering the vehicle interior. The sun visor main body 2 is attached to the ceiling of the vehicle interior via a substantially L-shaped holding shaft 10. More specifically, the base end of the holding shaft 10 is fixed to a desired portion of the ceiling of the vehicle interior via an attachment bracket 10a. The tip of the holding shaft 10 is rotatably inserted into a metal bearing member (not shown) provided within the sun visor main body 2. This structure allows the sun visor main body 2 to be supported in the substantially horizontal direction by the holding shaft 10. The structure also allows the sun visor main body to be switched between a withdrawn position along the ceiling of the vehicle interior and a blocking position along the front glass of the vehicle by rotating the sun visor main body 2 around the holding shaft 10. A supporting shaft 12 is provided at the upper left end of the sun visor main body 2 so as to be rotatably received by a not-shown synthetic resin hook secured to the interior of the vehicle.

As illustrated in FIGS. 1 and 2, the sun visor main body 2 includes the annular external frame 3 provided along the outer edge of the sun visor main body 2, and the plate member 4. The plate member 4 is releasably attached in such a position as to fill or occupy an open window 5 penetrating the central portion of the external frame 3.

As illustrated in FIG. 4, the external frame 3 is split into two parts. The first part of the external frame 3 is a front-side split part 3a facing the vehicle interior when the sun visor main body 2 is lowered to the blocking position. The other part of the external frame 3 is a backside split part 3b facing the front glass when the sun visor main body 2 is lowered to the blocking position. The front-side and the backside split parts 3a and 3b are each made of a hard thermoplastic resin such as polypropylene and formed into a frame shape via injection molding. The split parts 3a and 3b are connected to each other, for example through the engagement between pins 51 and bosses 52 provided on the inner surfaces of the respective split parts 3a and 3b.

As illustrated in FIGS. 1, 2, and 4, the plate member 4 may be made of a hard thermoplastic synthetic resin such as polypropylene (PP), polycarbonate (PC), polymethyl methacrylate (PMMA) and formed into a thin plate, or the plate member 4 may be made of metal such as iron, steel, or aluminum for example, and formed into a thin plate. A plurality of see-through vision holes 6, which in this example are substantially circular and penetrate through the thickness of the plate member 4, are provided at substantially regular intervals across the surface of the plate member 4. A passenger or the like sitting inside the vehicle can visually observe the conditions outside of the vehicle through the see-through vision holes 6 while reducing the glare and intensity of light to some extent by the plate member 4. The plate member 4 having the see-through vision holes 6 corresponds to a “perforated plate” in the invention.

As illustrated in FIG. 2, an insertion opening 7, through which one end of the plate member 4 is inserted, is provided along one side of the external frame 3. When one end of the plate member 4 is inserted from the insertion opening 7 the plate member 4 slides along the sliding groove 8, which is concave and provided along the outer edge of the open window 5, as shown in FIG. 4. Thus, the outer edge of the plate member 4 is held in such a manner as to be slidable in the right-to-left direction (e.g., indicated by an arrow G in FIG. 2) along the sliding groove 8. Simply sliding the plate member 4 along the sliding groove 8 easily carries out the attachment and detachment of the plate member 4 to and from the external frame 3. The insertion opening 7 provided along the side of the external frame 3 and the sliding groove 8, which is concave and formed along the outer edge of the open window 5, collectively correspond to a “sliding structure” in the invention.

A convex portion or the like, which is graspable with fingers in order to be removed or inserted, is formed at one end of the plate member 4. The passenger of the vehicle or the like can easily slide the plate member 4 by holding onto the convex portion with their fingers. Consequently, in this case the attachment and detachment of the plate member 4 to and from the external frame 3 can be readily facilitated.

As illustrated in FIGS. 1 through 3, a cover cap 60 for preventing the inadvertent removal of the plate member 4 is provided at the insertion opening 7 formed along the side of the external frame 3. The plate member 4 is inserted from the insertion opening 7 and disposed in such a position as to substantially fill or occupy the open window 5. The cover cap 60 has an inserted portion 61. The inserted portion 61 is inserted into the insertion opening 7 and may contact the side edge of the plate member 4. The inserted portion 61 restricts the right-to-left (i.e., horizontal) directional movement of a plate member 4 positioned so as to substantially occupy the open window 5. As a result, while the vehicle is running, for example, it is possible to prevent the right-to-left directional displacement of the plate member 4 from a position substantially occupying the open window 5.

According to the vehicle sun visor 1 described above, the attachment and detachment of the plate member 4 as a part of the sun visor main body 2 can be easily carried out. Consequently, the design of the sun visor main body 2 can be freely changed. For example, when a plurality of the plate members 4 having designs differing in pattern, color, and the like, are prepared, a wide variety of vehicle sun visor 1 designs can be obtained by simply replacing the plate members 4 with differently designed or styled plate members 4. Since the external appearance of the vehicle sun visor 1 can be varied in accordance with the taste and wishes of the user or the like, the product value of the vehicle sun visor 1 can be considerably increased.

In the vehicle sun visor 1 described above, replacing the plate member 4 may alter the transmissibility of light. For example, when a plate member 4 having a plurality of see-through vision holes 6 throughout the surface thereof (see FIGS. 1 and 2) and a plate member 4 having no see-through vision holes 6 are prepared in advance, the transmissibility of light entering from the outside of the vehicle can be controlled by switching between the two types of plate members 4 in accordance with the purpose of use by the passenger or the like. For example, when the passenger of the vehicle is inconvenienced by intense sunlight and glare entering from the environment outside of the vehicle, attaching the plate member 4 having no see-through vision holes 6 to the external frame 3 can more securely block the sunlight from entering the interior of the vehicle. On the other hand, when a passenger wants to more accurately verify and observe the traffic conditions or the like outside of the vehicle interior while still blocking sunlight and the like from entering from outside of the vehicle, higher visibility may be obtained by attaching to the external frame 3 the plate member 4 having see-through vision holes 6 throughout the surface of the plate member 4.

When the plate member 4 is made of a transparent plate or semi-transparent plate such as acrylic resin, the transmissibility of light entering from the outside of the vehicle can be more flexibly controlled in accordance with the purpose of use by the passenger or the like. In addition, the novelty of the appearance of the vehicle sun visor 1 can be more enhanced when a transparent or semi-transparent plate forms the plate member 4.

It is also possible to use a plate member 4a illustrated in FIG. 5, for example, in the vehicle sun visor 1 described above. The plate member 4a shown in FIG. 5 includes a first sheet 14 having a pattern, design, color, or the like, on its surface. A second sheet 15 is disposed beneath the lower surface of the first sheet 14. Two transparent plates 16 and 17 are disposed in lamination in such positions that the front face of the first sheet 14 and the back face of the second sheet 15 are sandwiched between the transparent plates 16 and 17.

The first sheet 14 and second sheet 15 are thin sheet components having a pattern, design, color, and the like, on their surfaces, for example such as paper, cloth, and resin film. The two transparent plates 16 and 17 are non-opaque plates made of acrylic resin, for example. Laminating the first sheet 14, the second sheet 15, and the two transparent plates 16 and 17, form the plate member 4a. The design of the front face or back face of the vehicle sun visor 1 can easily be changed by simply replacing the first sheet 14 or the second sheet 15. For example, when a plurality of the first sheets 14 are prepared, on which pictures or the like are printed, the design of the front face of vehicle sun visor 1 can be easily changed in accordance with the feeling or taste of the user by a simple replacement of the first sheet 14.

The plate member 4a is attached in such a position so as to substantially occupy the open window 5 provided at the center of the external frame 3. As a result, the replacement of the first sheet 14 changes the design of the front face of the vehicle sun visor 1. Conversely, the replacement of the second sheet 15 changes the design of the back face of the vehicle sun visor 1. Furthermore, the replacement of both of the first sheet 14 and the second sheet 15 of the plate member 4a simultaneously changes the designs of the front and the back faces of the sun visor 1.

It is also possible to print safety-warning indications for product use (i.e., so-called “caution indications”) on the surface of the first sheet 14 disposed between the two transparent plates 16 and 17. Alternatively, a sticker or the like on which safety-warning indications are printed can be affixed to the surface of the first sheet 14. In this case, since the transparent plate 16 is attached to the surface of the first sheet 14, the blurring or erasing of the printed safety-warning indications due to external causes such as heat, friction, dust, damage, or the like, is effectively prevented.

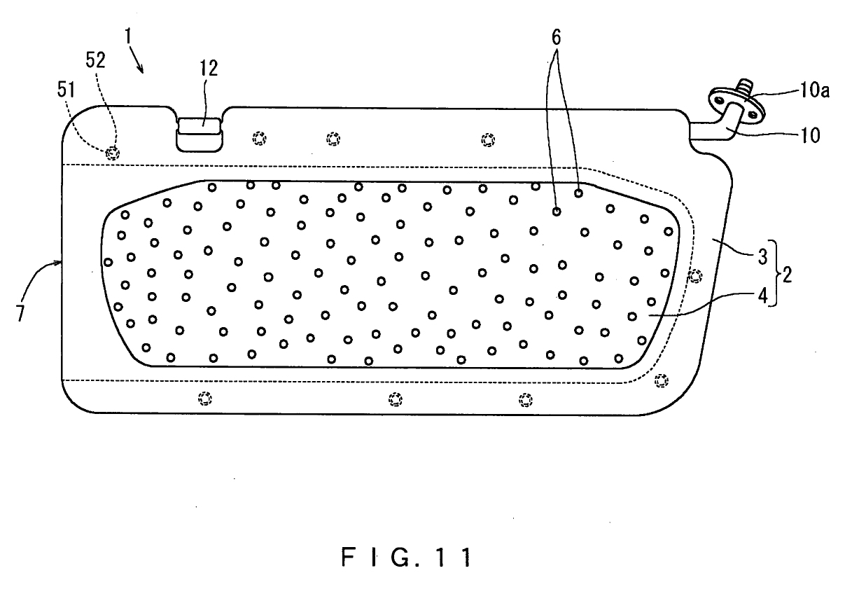

While the vehicle sun visor 1 has a cover cap 60 for the insertion opening 7 (through which the plate member 4 is inserted) in the first embodiment, the cover cap 60 is not necessarily needed for the insertion opening 7. For example, as shown in FIG. 11, even in a vehicle sun visor 1 only having the insertion opening 7 along the side of the external frame 3 with no separately provided cover cap 60, the attachment and detachment of the plate member 4 to and from the external frame 3 can be facilitated.

### Second Embodiment

A second embodiment according to the invention is hereinafter described with reference to the drawings.

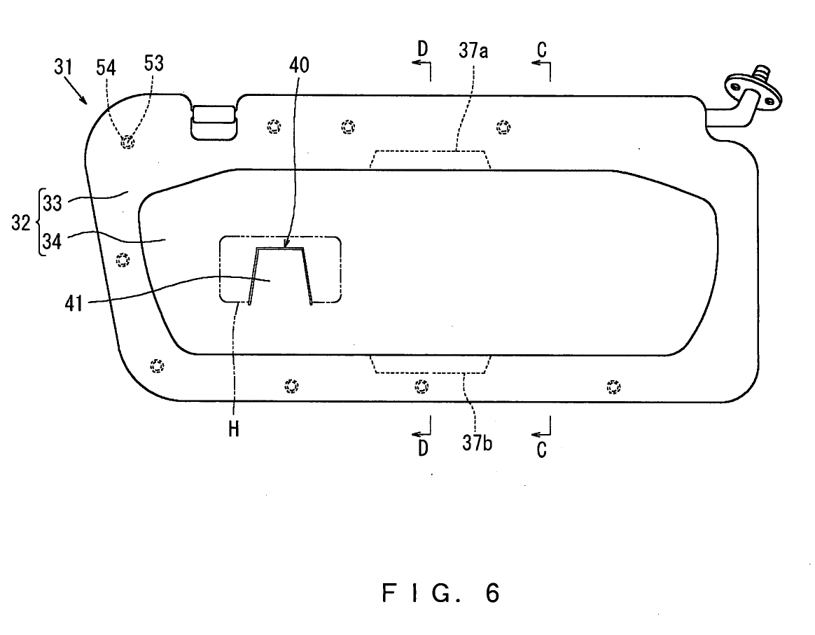

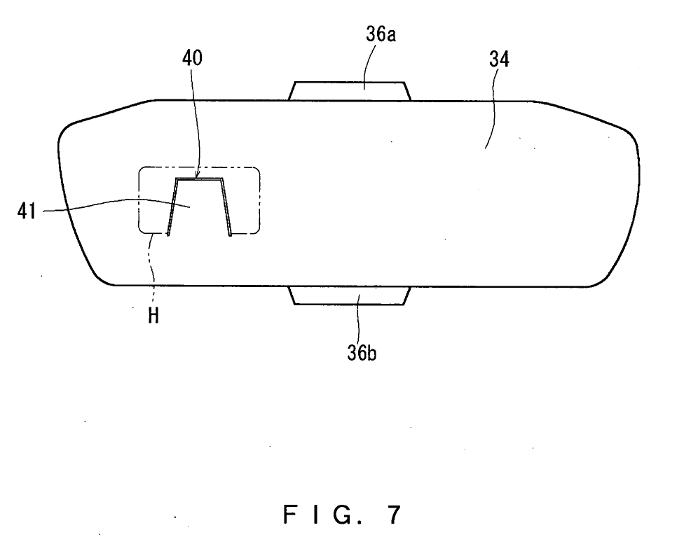

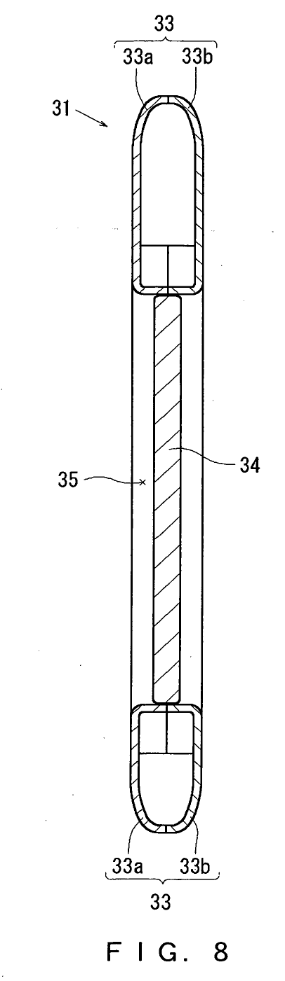

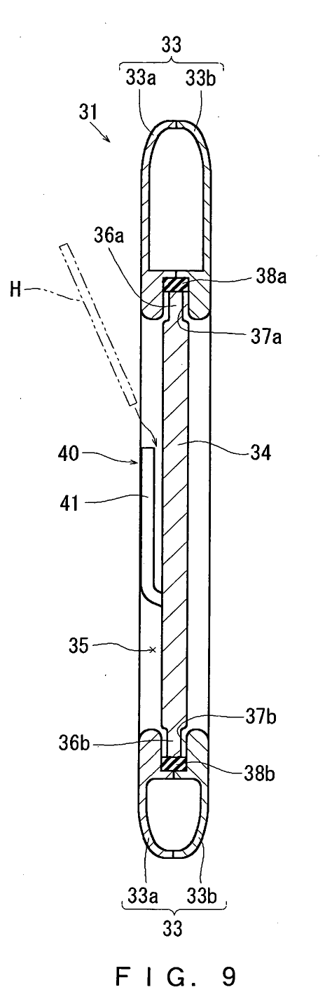

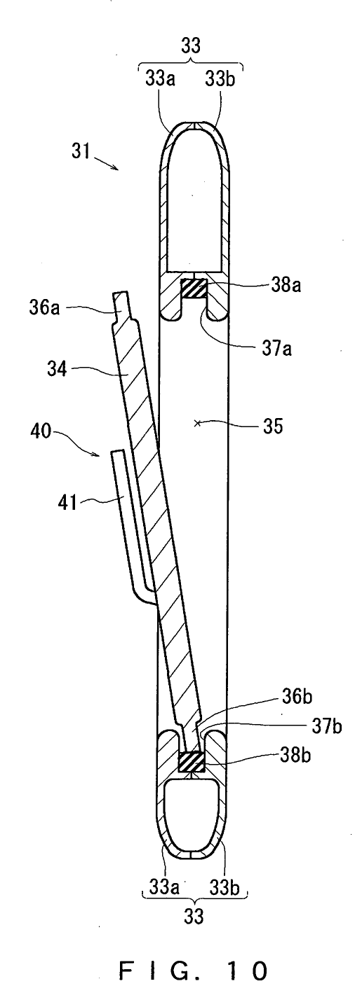

FIG. 6 is a front view illustrating the external appearance of a vehicle sun visor 31 of a second embodiment. FIG. 7 is a front view of a plate member 34 of the sun visor 31 shown in FIG. 6. FIG. 8 is a cross-sectional view of the vehicle sun visor 31 shown in FIG. 6 taken along a line C-C as viewed in the direction indicated by the arrows of the line C-C. FIG. 9 is a cross-sectional view of the vehicle sun visor 31 shown in FIG. 6 taken along a line D-D as viewed in the direction indicated by the arrows of the line D-D. FIG. 10 is a cross-sectional view illustrating a condition at the time of attachment of the plate member 34 to an external frame 33.

As illustrated in FIG. 6, the vehicle sun visor 31 in this embodiment is chiefly constituted by a sun visor main body 32 used for blocking sunlight or the like from entering the vehicle interior. The sun visor main body 32 includes the external frame 33, which is frame-shaped and provided along the outer edge of the sun visor main body 32, and the plate member 34, which is releasably attached in such a position so as to substantially occupy an open window 35 formed at the center of the external frame 33.

As illustrated in FIG. 8, the external frame 33 is split into two parts. One part of the external frame 33 is a front-side split part 33a facing the vehicle interior when the sun visor main body 32 is lowered to the blocking position. The other part of the external frame 33 is a backside split part 33b facing the front glass when the sun visor main body 32 is lowered to the blocking position. The front-side and backside split parts 33a and 33b may be made of hard thermoplastic resin such as polypropylene and formed into a frame shape by injection molding. The split parts 33a and 33b are connected with each other by the engagement between pins 51 and bosses 52 provided on the inner surfaces of the respective split parts 33a and 33b.

The plate member 34 may be made of hard thermoplastic synthetic resin such as polypropylene (PP), polycarbonate (PC), or polymethyl methacrylate (PMMA), and formed into a thin plate. As illustrated in FIGS. 7, 9, and 10, convex protrusions 36a and 36b are respectively provided at the upper and lower ends of the plate member 34. The convex protrusions 36a and 36b engage with corresponding concaves 37a and 37b formed in the vicinity of the upper and lower edges of the open window 35.

When the plate member 34 is attached to the external frame 33, the convex protrusion 36b, formed at the lower edge of the plate member 34, is inserted from above diagonally into the concave 37b formed in the vicinity of the lower end of the open window 35 as illustrated in FIG. 10. A rubber member 38b, which resiliently expands and contracts, is provided within the concave 37b. The convex protrusion 36a pushes against and compresses the rubber member 38b allowing the convex protrusion 36a formed at the upper end of the plate member 34 to be inserted into the concave 37a. Since the resilient forces of the rubber member 38a and the rubber member 38b are applied to the upper and lower regions of the plate member 34, the plate member 34 is rigidly fixed while occupying the open window 35.

On the other hand, the procedures for detaching the plate member 34 from the external frame 33 are the same as the procedures for attaching the plate member 34, performed in reverse order.

As illustrated in FIGS. 6 and 9, the plate member 34 in this embodiment is provided with a cardholder 40 for holding a card H of various types, for example such as a credit card and a pre-paid card. The cardholder 40 has a holding piece 41 which projects from the surface of the plate member 34. The card H is inserted from above into a space between the holding piece 41 and the surface of the plate member 34.

According to the vehicle sun visor 31 in the second embodiment described above, attachment and detachment (i.e., fitting and removal) of the plate member 34 can be readily performed via the engagement between the convexes 36a and 36b and the concaves 37a and 37b. As a result, when a plurality of plate members 34 having different patterns and the like are prepared in advance, the design of the vehicle sun visor 31 can be easily changed simply by the replacement of the plate members 34.

Moreover, it is possible to provide a cardholder 40 or other additional functions with the plate member 34. Accordingly, when a plurality of the plate members 34 having different functions are prepared, the function of the vehicle sun visor 31 can be easily changed simply by exchanging the plate members 34. For example, when plural plate members 34 having various different functions such as a vanity mirror, a map lamp, and other functions in addition to or in place of the card holder 40, are prepared in advance, the function of the vehicle sun visor 31 can be easily altered in accordance with the purpose of use by the passenger or the like.

According to the vehicle sun visor 31 of the second embodiment, a plate member formed by a perforated plate, a semi-transparent plate, or the like, a multilayer plate, which includes a sheet having a design and a transparent plate or plates disposed on the surface of the sheet, or other plate members, can be employed as in the vehicle sun visor 1 according to the first embodiment.

The invention is not limited to the first and second embodiments described above, but may be appropriately modified without departing from the scope of the invention.

In the above embodiments, the sun visor main body is chiefly exemplified as being made of thermoplastic synthetic resin and may be manufactured by injection molding. However, the invention is applicable to a case where the sun visor main body is produced by other various methods, e.g., a sun visor main body made of thermoplastic synthetic resin and formed by such methods as blow forming and bead foaming. The material of the sun visor main body is not limited to thermoplastic synthetic resin, but may be any other suitable material such as rubber and metal.

While the example of a vehicle sun visor used for blocking light entering through the front glass of the vehicle is shown in the above embodiments, the invention is also applicable to a vehicle sun visor for blocking light coming through the side glass, for example.

1. A vehicle sun visor comprising a sun visor main body that comprises:
an external frame attached to the interior of a vehicle via a supporting shaft; and
a plate member releasably attached in such a position so as to occupy an open window penetrating a central portion of the external frame, wherein:
the external frame has a sliding structure that allows the plate member to be slidingly attached.

2. A vehicle sun visor as set forth in claim 1, wherein the sliding structure comprises:
an insertion opening provided along a side of the external frame, and
a sliding groove for slidably engaging at least an outer edge of the plate member inserted through the insertion opening.

3. A vehicle sun visor as set forth in claim 2, wherein:
a cover cap is provided at the insertion opening to restrict movement of the plate member.

4. A vehicle sun visor comprising a sun visor main body that comprises:
an external frame attached to an interior of a vehicle via a supporting shaft; and
a plate member releasably attached in such a position so as to cover an open window located at a central portion of the external frame, wherein:
the external frame comprises a concave portion, and
the plate member comprises a corresponding convex portion,
wherein the engagement between the concave portion and the convex portion allows an attachment and detachment of the plate member to and from the external frame.

5. A vehicle sun visor as set forth in claim 1, wherein the plate member comprises:
at least one sheet having a design, and
at least one transparent plate disposed on at least one face of the at least one sheet.

6. A vehicle sun visor as set forth in claim 1, wherein the plate member comprises a light transmissibility controlling plate.

7. A vehicle sun visor as set forth in claim 2 wherein the plate member comprises:
at least one sheet member having a design, and
at least one transparent plate disposed on at least one face of the at least one sheet.

8. A vehicle sun visor as set forth in claim 4 wherein the plate member comprises:
at least one sheet member having a design, and
at least one transparent plate disposed on at least one face of the at least one sheet.

9. A vehicle sun visor as set forth in claim 6, wherein the light transmissibility controlling plate is a semi-transparent plate.

10. A vehicle sun visor as set forth in claim 6, wherein the light transmissibility controlling plate is a perforated plate.

11. A vehicle sun visor as set forth in claim 4 wherein the plate member comprises a light transmissibility controlling plate.

12. A vehicle sun visor as set forth in claim 11, wherein the light transmissibility controlling plate is a semi-transparent plate.

13. A vehicle sun visor as set forth in claim 11, wherein the light transmissibility controlling plate is a perforated plate.

14. A vehicle sun visor as set forth in claim 1, wherein the plate member comprises at least one plate providing the performance of at least one function.

15. A vehicle sun visor as set fort in claim 14, wherein the at least one plate provides a cardholding function.

16. A vehicle sun visor as set forth in claim 4, wherein the plate member comprises at least one plate providing the performance of at least one function.

17. A vehicle sun visor as set fort in claim 16, wherein the at least one plate provides a cardholding function.

18. A vehicle sun visor comprising a sun visor main body that comprises:
an external frame attached to the interior of a vehicle via a supporting shaft;
a plate member releasably attached in such a position so as to at least fill an area of an open window surrounded by the external frame; and
a cover cap;
wherein the external frame comprises a sliding structure that slidingly attaches the plate member to the external frame,
wherein the sliding structure comprises:
an insertion opening provided along a side of the external frame; and
a sliding groove for slidably engaging at least an outer edge of the plate member inserted through the insertion opening;
wherein the cover cap is provided at the insertion opening to restrict movement of the plate member.

19. A vehicle sun visor as set forth in claim 18, wherein the plate member comprises:
at least one sheet member having a design, and
at least one transparent plate disposed on at least one face of the at least one sheet.

20. A vehicle sun visor as set forth in claim 18 wherein the plate member comprises a light transmissibility controlling plate.
